(19) United States
(12) Patent Application Publication
(10) Pub. No.: US 2006/0012332 A1
(43) Pub. Date: Jan. 19, 2006

(54) Latch mechanism

(75) Inventor: Fang-Ming Peng, Jiangsu (CN)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/167,392

(22) Filed: Jun. 28, 2005

(30) Foreign Application Priority Data
Jul. 16, 2004 (TW) 93121273

(51) Int. Cl. H02J 7/00

(52) U.S. Cl. 320/107

(57) ABSTRACT

A latch mechanism for a battery. A movable member is movably disposed on a main body along a first direction, comprising a first slanting surface, angled with respect to the first direction. A first slider is movably disposed in the main body, comprising a first joining portion joining to a second joining portion of the battery when the movable member is in a first position. When the movable member moves to a second position along a first direction, the first slanting surface impels the first slider along a second direction such that the first and second joining portions are separated.

### BACKGROUND

The present invention relates in general to a latch mechanism and in particular to a latch mechanism for fixing a mobile phone battery.

Referring to FIG. 1, a conventional mobile phone 1 comprises a main body C and a battery B disposed therein. A pair of movable latch members P fix the battery B in the main body C. To remove the battery B, both latch members P are moved as the arrows indicate such that the battery B can be separated from the upper side of the main body C as shown in FIG. 1.

Since the battery B is generally positioned in a depression of the main body as shown in FIG. 1, however, access thereto for convenient removal is limited.

### SUMMARY

Latch mechanisms are provided. An exemplary embodiment of a latch mechanism for a battery comprises a main body, a movable member and a first slider. The movable member is movably disposed on the main body along a first direction, having a first slanting surface with respect to the first direction. The first slider is movably disposed in the main body, having a first joining portion connected to a second joining portion of the battery when the movable member is in a first position. When the movable member moves to a second position along the first direction, the first slanting surface impels the first slider along a second direction such that the first and second joining portions are separated.

An embodiment of the latch mechanism further comprises a second slider, and the movable member further has a second slanting surface angled with respect to the first direction. The second slanting surface impels the second slider opposite to the second direction, thereby impelling and ejecting the battery from the latch mechanism.

Another exemplary embodiment of a latch mechanism comprises a main body a movable member, a first slider and a flexible member. The movable member is movably disposed on the main body along a first direction, having a first slanting surface with respect to the first direction. The first slider is movably disposed in the main body, having a first joining portion connected to a second joining portion of the battery when the movable member is in a first position. The flexible member is disposed in a depression of the main body and situated between the main body and the battery. When the movable member moves from the first position to a second position in the first direction, the first slanting surface impels the first slider along a second direction, such that the first and second joining portions are separated, and the flexible member exerts a spring force ejecting the battery from the depression.

### BRIEF DESCRIPTION OF THE DRAWINGS

The invention will be more fully understood from the following detailed description and the accompanying drawings, given by way of illustration only and thus not intended to limit the disclosure.

FIG. 1 is a perspective diagram of a conventional mobile phone;

FIG. 2a is a perspective diagram of a movable member in a first position according to the first embodiment of the invention;

FIG. 2b is a top view of the movable member and the first slider in accordance with FIG. 2a;

FIG. 3 is a perspective diagram of the movable member in a second position according to the first embodiment of the invention;

FIG. 4 is a perspective diagram of the movable member in a third position according to the first embodiment of the invention; and

FIGS. 5a and 5b are perspective diagrams of the second embodiment of the invention.

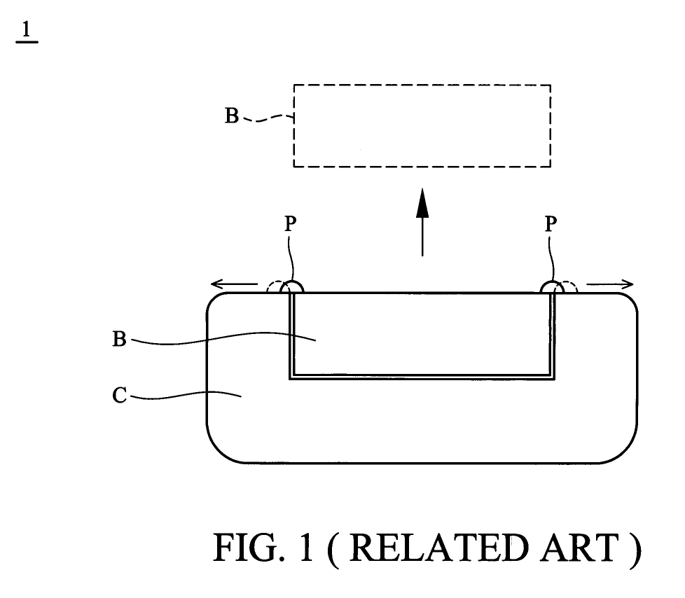

### DETAILED DESCRIPTION

### First Embodiment

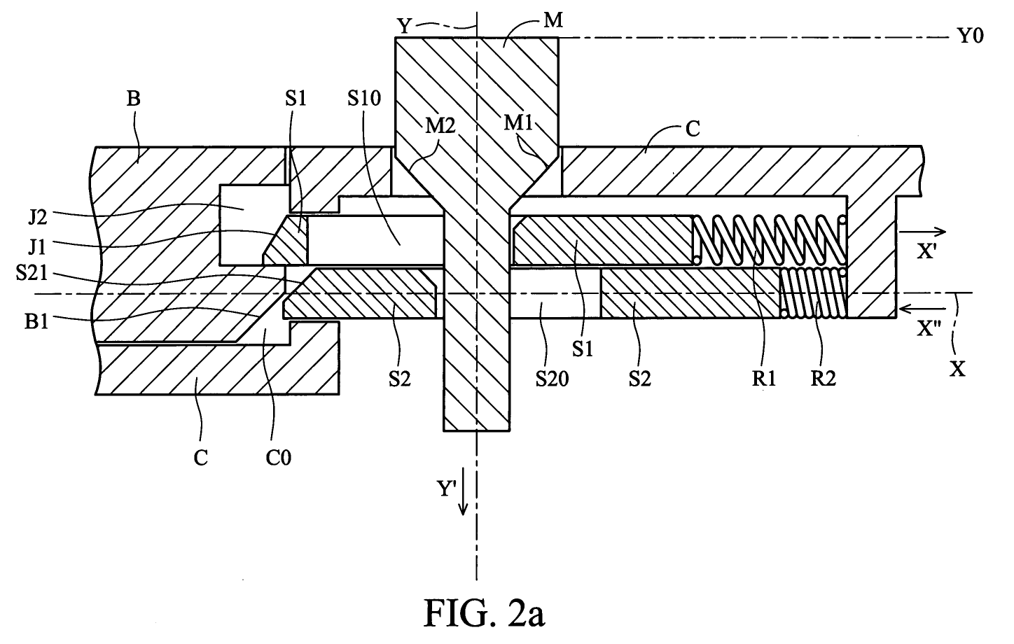

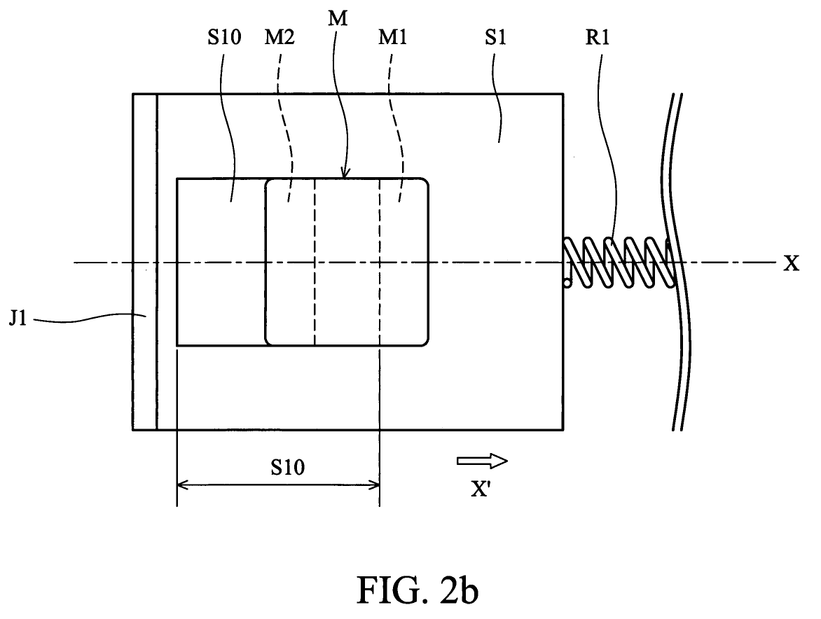

Referring to FIG. 2a, a latch mechanism for a battery or other detachable component in a phone device (such as a mobile phone) primarily comprises a main body C, a movable member M, a first slider S1 and a second slider S2. The movable member M can slide with respect to the main body C along a Y axis, and the first and second sliders S1 and S2 are movable along a X axis substantially perpendicular to the Y axis.

As shown in FIG. 2a, a removable battery B is disposed in a depression C0 of the main body C. The first slider S1 has a first joining portion J1 at one end thereof, and correspondingly, the battery B has a second joining portion J2 receiving the first joining portion J1. Here, the second joining portion J2 is a recess with the first joining portion J1, received therein, fixing the battery B in the depression C0.

The movable member M is movable along the Y axis, passing sequentially through the main body C, an opening S10 of the first slider S1, and an opening S20 of the second slider S2. As shown in FIG. 2a, when the movable member M is in a first position Y0 on axis Y, the first slider S1 is impelled leftward by a first resilient element R1, thereby fixing the battery B. The first resilient element R1 is a compression spring disposed between the main body C and the first slider S1. Referring to FIGS. 2a and 2b, the movable member M passes through the opening S10 of the first slider S1, and the first slider S1 is movable in direction X′ by the movable member M.

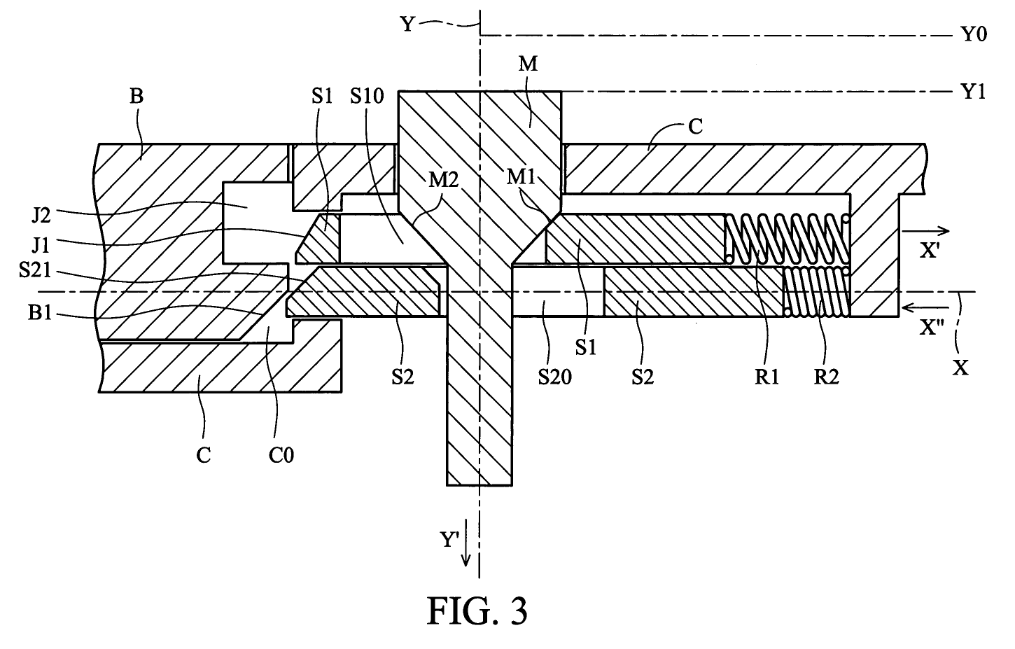

Referring to FIG. 3, the movable member M comprises a first slanting surface M1 and a second slanting surface M2, angled with respect to the X and Y axes. When the movable member M moves downward from the first position Y0 to a second position Y1 in direction Y′, the first slider S1 is impelled rightward in direction X′ by the first slanting surface M1, thereby separating the first joining portion J1 from the second joining portion J2 and releasing the battery B from the depression C0. The moving directions Y′ and X′ of the movable member M and the first slider S1 form an included angle, as shown in FIG. 3, rendering them substantially perpendicular here.

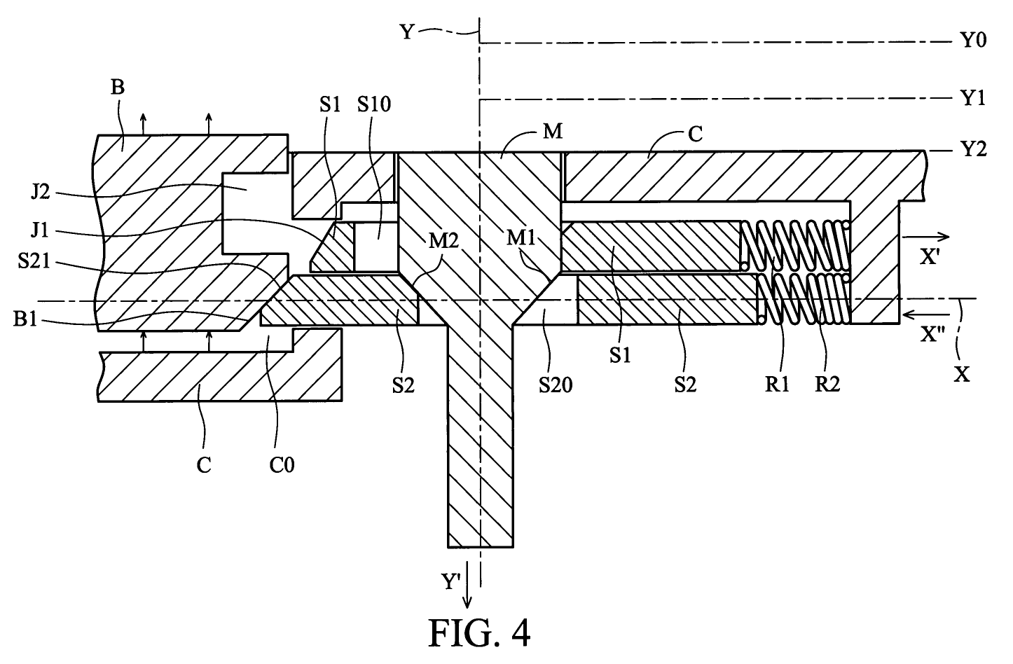

Referring to FIG. 4, the second slider S2 comprises a first contact surface S21 at one end thereof, and correspondingly, the battery B comprises a second contact surface B1. When the movable member M moves downward from the second position Y1 to a third position Y2 in direction Y′, the second slider S2 is impelled leftward by the second slanting surface M2 of the movable member M in direction X″ (opposite to direction X′) such that the first contact surface S21 abuts the second contact surface B1. As the first and second contact surfaces S21 and B1 are inclined with respect to direction Y′, the battery B is ejected from the depression C0 by the first contact surface S21 contacting the second contact surface B1 in direction X″.

As shown in FIG. 4, the resilient element R2 is a tension spring, connecting the main body C and the second slider S2 and exerting spring force on the second slider S2 in the second direction X′. Upon insertion of the battery B into the depression C0, the second slider S2 moves to the right and impels the movable member M upward via the second slanting surface M2. As the movable member M returns to the first position Y0 from the third position Y2, the first resilient element R1 impels the first slider S1 moving leftward, whereby the first joining portion J1 is received in the second joining portion J2 and the battery B is secured.

### Second Embodiment

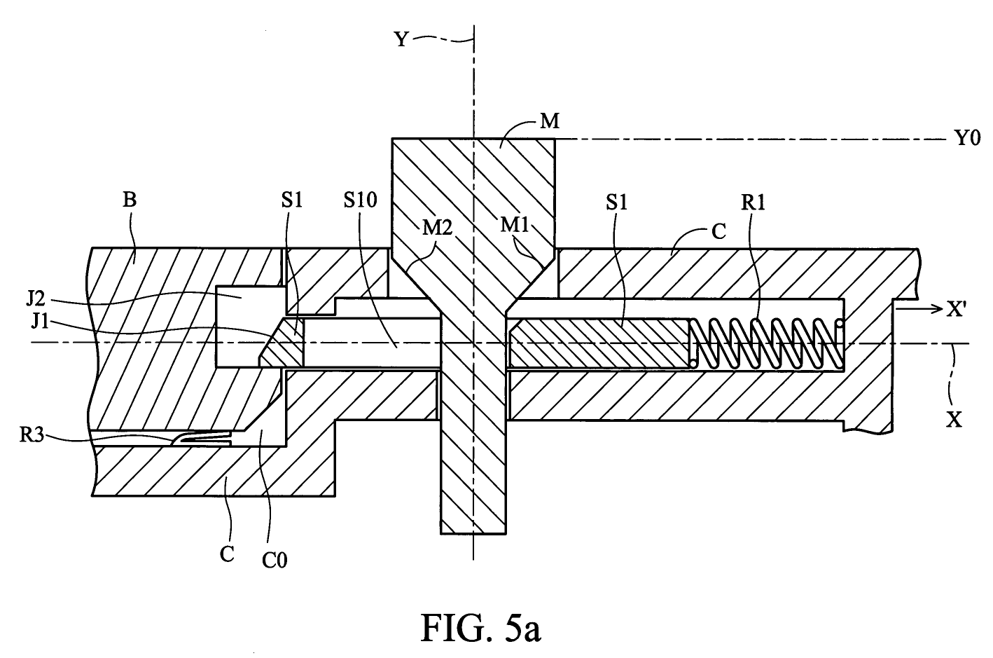

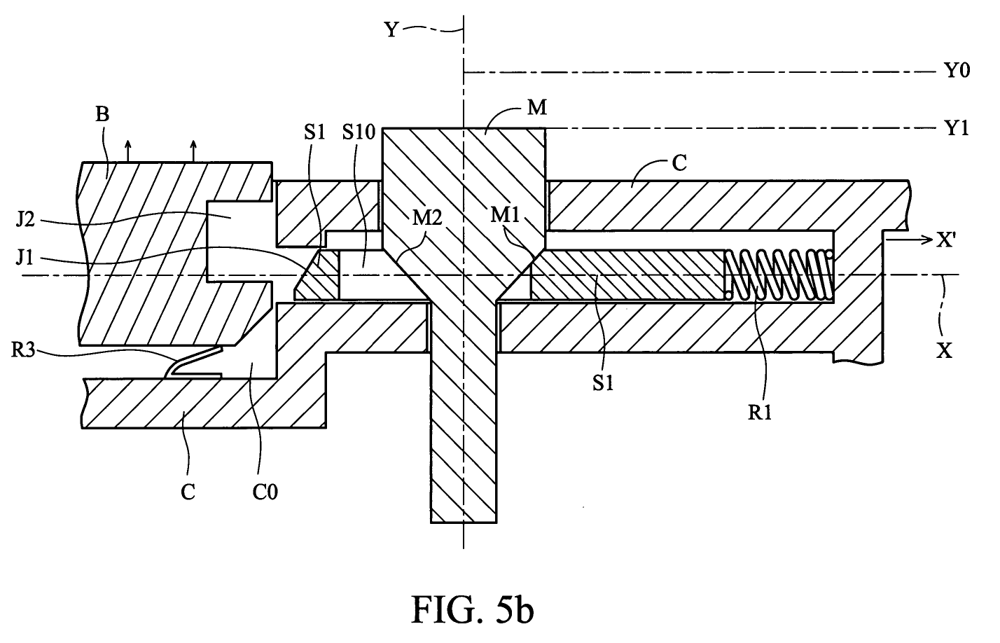

Referring to FIGS. 5a and 5b, the second slider S2 can be substituted with a flexible member R3 disposed on the depression C0 surface capable of ejecting the battery B. Here, the flexible member R3 is a metal sheet exerting spring force upward on the battery B. When the movable member M is in the first position Y0, the first slider S1 is impelled leftward by the first resilient element R1 such that the first joining portion J1 enters the second joining portion J2, thereby securing the battery B. As shown in FIG. 5a, the flexible member R3 is compressed when the battery B is fixed in the depression C0.

In FIG. 5b, when movable member M moves downward from the first position Y0 to a second position Y1 along the Y axis, the first slider S1 is impelled rightward by the first slanting surface M1 in the direction X′, thereby separating the first joining portion J1 from the second joining portion J2. The battery B is then released and automatically ejected from the depression C0 by the flexible member R3 exerting the spring force upward, as the arrows indicate in FIG. 5b.

In summary, embodiments of the invention provide a latch mechanism by which a battery may be easily and securely fixed, and it may also be easily ejected from a device.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A latch mechanism for a battery, comprising:
a main body;
a movable member movably disposed on the main body along a first direction, having a first slanting surface with respect to the first direction; and
a first slider movably disposed in the main body, having a first joining portion connected to a second joining portion of the battery when the movable member is in a first position, and when the movable member moves to a second position along the first direction, the first slanting surface impels the first slider along a second direction such that the first and second joining portions are separated.

2. The latch mechanism as claimed in claim 1 further comprising a second slider, and the movable member further comprising a second slanting surface, angled with respect to the first direction, wherein the second slanting surface impels the second slider opposite to the second direction, thereby impelling and ejecting the battery from the latch mechanism.

3. The latch mechanism as claimed in claim 1, wherein the second joining portion comprises a recess receiving the first joining portion.

4. The latch mechanism as claimed in claim 1 further comprising a first resilient element connecting the main body and the first slider.

5. The latch mechanism as claimed in claim 2 further comprising a second resilient element connecting the main body and the second slider.

6. The latch mechanism as claimed in claim 2, wherein the second position is between the first position and the third position.

7. The latch mechanism as claimed in claim 2, wherein the first slider comprises a first opening and the second slider comprises a second opening with the movable member passing therethrough.

8. The latch mechanism as claimed in claim 2, wherein the second slider comprises a first contact surface and the battery comprises a second contact surface, both angled with respect to the first direction, and the first contact surface abuts the second surface when the movable member moves to the third position.

9. The latch mechanism as claimed in claim 2, wherein the second slider ejects the battery opposite to the first direction when the movable member moves to the third position.

10. A phone, comprising:
a main body, having a depression;
a movable member movably disposed on the main body along a first direction, having a first slant surface, angled with respect to the first direction;
a first slider movably disposed in the main body, having a first joining portion;
a second slider movably disposed in the main body; and
a battery detachably disposed in the depression, having a second joining portion, wherein the first and second joining portions are joined when the movable member is in a first position, and when the movable member moves to a second position along a first direction, the first slanting surface impels the first slider moving along a second direction such that the first and second joining portions are separated.

11. The phone as claimed in claim 10, wherein the movable member further comprises a second slanting surface, angled with respect to the first direction, impelling the second slider moving opposite to the second direction when the movable member moves to a third position along the first direction, such that the second slider ejects the battery from the main body.

12. The phone as claimed in claim 10, wherein the movable member passes through the main body.

13. The phone as claimed in claim 12, wherein the movable member passes through the main body, the first, and the second sliders sequentially.

14. A latch mechanism for a battery, comprising:
a main body, having a depression;
a movable member movably disposed on the main body along a first direction, having a first slanting surface, angled with respect to the first direction;
a first slider movably disposed in the main body, having a first joining portion connected to a second joining portion of the battery when the movable member is in a first position; and
a flexible member disposed in the depression between the main body and the battery, wherein when the movable member moves to a second position from the first position in the first direction, the first slanting surface impels the first slider along a second direction to separate the first joining portion from the second joining portion, and the flexible member exerts a spring force ejecting the battery from the depression.

15. The latch mechanism as claimed in claim 14, wherein the second joining portion is a recess receiving the first joining portion.

16. The latch mechanism as claimed in claim 14, wherein the battery is ejected from the depression opposite the first direction by the flexible member.

17. The latch mechanism as claimed in claim 14, wherein the flexible member is a metal sheet.
